(19) United States
(12) Patent Application Publication
(10) Pub. No.: US 2018/0349891 A1
(43) Pub. Date: Dec. 6, 2018

(54) SYSTEMS AND METHODS FOR ONLINE PAYMENT PROCESSING USING SECURE INLINE FRAMES

(71) Applicant: Bluefin Payment Systems LLC, Atlanta, GA (US)

(72) Inventors: Grant Putre, Roswell, GA (US); Donal McCarthy, Waterford (IE)

(21) Appl. No.: 15/997,205

(22) Filed: Jun. 4, 2018

Related U.S. Application Data
(60) Provisional application No. 62/514,324, filed on Jun. 2, 2017.

(51) Int. Cl. G06Q 20/38; G06Q 20/40; G06Q 20/34

(52) U.S. Cl. CPC G06Q 20/385; G06Q 20/34; G06Q 20/4012

(57) ABSTRACT

Systems and methods for facilitating online payments via an HTML document embedded inside another HTML document on a payee website (e.g., an “inline frame” or “iFrame”). Generally, the iFrame permits a payor (e.g., customer, constituent, donor, etc.) to pay for a transaction (e.g., purchase, utilities payment, fine, donation, dues, etc.) on the payee's web site without requiring the payee (e.g., merchant, utilities provider, government entity, non-profit, etc.) to handle the payor's payment data (e.g., credit card information, bank account information, blockchain-based transaction information, etc.). Further, the iFrame permits the payor to pay for a transaction on the payee's website without requiring the payor to leave the payee's website.

### CROSS REFERENCE TO RELATED APPLICATIONS

This application claims priority to, the benefit under 35 U.S.C. § 119 of, and incorporates by reference herein in its entirety, U.S. Provisional Patent Application No. 62/514,324, entitled “Secure iFrame,” and filed Jun. 2, 2017.

### TECHNICAL FIELD

The present systems and methods relate generally to online payment processing and, more particularly, to using embedded HTML documents to facilitate online payment processing.

### BACKGROUND

Every day, millions of payments are made online using the internet (e.g., paying for a purchase from a merchant, paying utilities, etc.), with the volume of transactions increasing exponentially each year. To process a payment, the payee (e.g., merchant, utilities provider, etc.) usually receives an individual's highly-sensitive payment information/data (e.g., payment card information, bank account information, etc.) and transmits that payment data to a payment processor that facilitates the payment transaction. Generally, each of those transactions represents an opportunity for theft of an individual's highly-sensitive payment data because that payment data has been shared with a third party (e.g., the payee) that could accidentally expose that payment data in a security breach.

To improve the security of the standard transaction process, some payees, instead of passing the payment data to a payment processor, send their customers directly to the payment processor's website to complete the transaction so that the payee never handles the payment data. This distributed transaction, however, is cumbersome and slow both from the customer and the payee's perspectives as it not only requires the customer to visit multiple websites but also requires the payee to reconcile multiple pieces of information to ensure the appropriate payment is made. Further, this distributed transaction reduces the amount of control that the payee has over some of the provided data (e.g., customer name, address, etc.)

Therefore, there is a long-felt but unresolved need for a system or method that facilitates online payments from a payee's website without requiring the payee to handle payment data.

### BRIEF SUMMARY OF THE DISCLOSURE

Briefly described, and according to one embodiment, aspects of the present disclosure generally relate to systems and methods for using embedded HTML documents to facilitate online payment processing from a payee's website without requiring the payee to handle payment data.

In various embodiments, the disclosed iFrame system facilitates online payments via an HTML document embedded inside another HTML document on a payee website (e.g., an “inline frame” or “iFrame,” wherein the embedded HTML document is the iFrame and the HTML document into which the iFrame is embedded is referred to as an “iFrame container”) that permits a payor (e.g., customer, constituent, donor, etc.) to pay for a transaction (e.g., purchase, utilities payment, fine, donation, dues, etc.) on the payee's website without requiring the payee (e.g., merchant, utilities provider, government entity, non-profit, etc.) to handle the payor's payment data (e.g., credit card information, bank account information, blockchain-based transaction information, etc.). This disclosure places no limitations on the types of payment data that can be received and processed using the iFrame system. Generally, the iFrame permits the payee website to receive and accept payment data without having any visibility into that payment data, instead passing the payment data directly to the iFrame system for payment processing. In various embodiments, as the payor is entering payment data onto a payee website including an iFrame, the payor is generally not directed to another website to do so and it appears to the payor as if the payee is receiving the payment data directly.

In various embodiments, after payment data is received via the iFrame, the iFrame system generates an eToken (e.g., an encrypted identifier used by the iFrame system and payee to identify the provided payment data) corresponding to the payment data and provides it back to the payee. The payee, generally, requests processing of the transaction by providing the eToken along with other relevant transaction data (e.g., transaction price, transaction identifier, etc.) to the iFrame system. Accordingly, the iFrame system, in various embodiments, determines the appropriate payment data corresponding to the transaction data and processes the transaction via the appropriate payment network (e.g., credit card company, bank, miner(s), etc.).

Generally, the iFrame system increases the security of a transaction by preventing access, by the payee, to the payment data. Further, the iFrame system makes the transaction more efficient as the payor does not have to visit another website and the payee does not have to go through a complicated transaction reconciliation process. Moreover, the iFrame system permits a payee to have more control over the handling of any non-sensitive data provided by the customer (e.g., name, address, contact information, etc.)—what data requested, what data is required, how the data is requested, etc.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary, high-level overview of one embodiment of the disclosed system.

FIG. 2 illustrates an exemplary architecture of one embodiment of the disclosed system.

FIG. 3 is a flowchart showing an exemplary iFrame system process, according to one embodiment of the present disclosure.

FIG. 4 is a flowchart showing an exemplary eToken generation process, according to one embodiment of the present disclosure.

FIG. 5 is a flowchart showing an exemplary eToken transaction process, according to one embodiment of the present disclosure.

FIG. 6 is a flowchart showing an exemplary payee system process, according to one embodiment of the present disclosure.

FIG. 7 illustrates an exemplary alternate architecture of one embodiment of the disclosed system.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to systems and methods for using embedded HTML documents to facilitate online payment processing from a payee's website without requiring the payee to handle payment data.

In various embodiments, the disclosed iFrame system facilitates online payments via an HTML document embedded inside another HTML document on a payee website (e.g., an “inline frame” or “iFrame,” wherein the embedded HTML document is the iFrame and the HTML document into which the iFrame is embedded is referred to as an “iFrame container”) that permits a payor (e.g., customer, constituent, donor, etc.) to pay for a transaction (e.g., purchase, utilities payment, fine, donation, dues, etc.) on the payee's website without requiring the payee (e.g., merchant, utilities provider, government entity, non-profit, etc.) to handle the payor's payment data (e.g., credit card information, bank account information, blockchain-based transaction information, etc.). This disclosure places no limitations on the types of payment data that can be received and processed using the iFrame system. Generally, the iFrame permits the payee website to receive and accept payment data without having any visibility into that payment data, instead passing the payment data directly to the iFrame system for payment processing. In various embodiments, as the payor is entering payment data onto a payee website including an iFrame, the payor is generally not directed to another website to do so and it appears to the payor as if the payee is receiving the payment data directly.

In various embodiments, after payment data is received via the iFrame, the iFrame system generates an eToken (e.g., an encrypted identifier used by the iFrame system and payee to identify the provided payment data) corresponding to the payment data and provides it back to the payee. The payee, generally, requests processing of the transaction by providing the eToken along with other relevant transaction data (e.g., transaction price, transaction identifier, customer name, customer address, etc.) to the iFrame system. Accordingly, the iFrame system, in various embodiments, determines the appropriate payment data corresponding to the transaction data and processes the transaction via the appropriate payment network (e.g., credit card company, bank, miner(s), etc.).

Generally, the iFrame system increases the security of a transaction by preventing access, by the payee, to the payment data (this separation may constrain actions emanating from the semi-trusted browser environment and limit them to validation, encryption and temporary storage). For example, with the iFrame, the capturing of the payment data is transformed from a semi-trusted process, wherein the payment data is encrypted and only temporarily stored, to a trusted process because the generated eToken is only valuable/useful when combined with the payee's API key (e.g., a unique identifier corresponding to the payee); thus, a hacker cannot manipulate transparent redirects to perform an authorization (with or without access to the API key) with an iFrame. Further, the iFrame system makes the transaction more efficient as the payor does not have to visit another website and the payee does not have to go through a complicated transaction reconciliation process. Moreover, the iFrame system permits a payee to have more control over the handling of any non-sensitive data provided by the customer (e.g., name, address, contact information, etc.)—what data requested, what data is required, how the data is requested, etc.

### Exemplary Embodiments

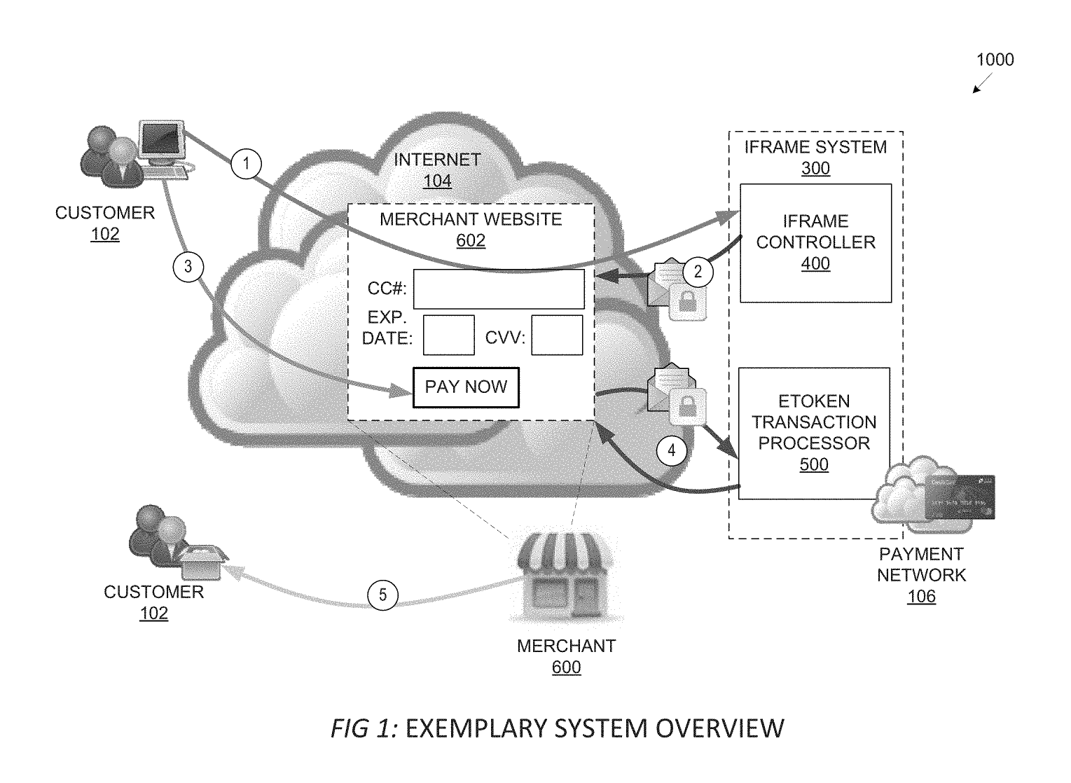

Referring now to the figures, for the purposes of example and explanation of the fundamental processes and components of the disclosed systems and methods, reference is made to FIG. 1, which illustrates an exemplary, high-level overview 1000 of one embodiment of an iFrame system 300. As will be understood and appreciated, the exemplary, high-level overview 1000 shown in FIG. 1 represents merely one approach or embodiment of the present system, and other aspects are used according to various embodiments of the present system. Generally, by way of example, and not by way of limitation, the high-level overview 1000 is shown in FIG. 1 with the help of a sequence of numbered steps indicated as steps “1” through “5,” which are annotated in circles.

In various embodiments, the iFrame system 300 facilitates online payments via an HTML document embedded inside another HTML document on a payee website 602 (e.g., an “inline frame” or “iFrame”) that permits a payor 102 (e.g., customer, constituent, donor, etc.) to pay for a transaction (e.g., purchase, utilities payment, fine, donation, dues, etc.) on the payee's website 602 without requiring the payee 600 (e.g., merchant, utilities provider, government entity, non-profit, etc.) to handle the payment data (e.g., credit card information, bank account information, blockchain-based transaction information, etc.) of the payor 102. Generally, the iFrame permits the payee website 602 to receive and accept payment data without having any visibility into that payment data, instead passing the payment data directly to the iFrame system 300 for payment processing. In various embodiments, as the payor 102 is entering payment data onto a website 602 that has deployed the disclosed systems and methods, the payor 102 is generally not directed to another website to do so and it appears to the payor 102 as if the payee 600 is receiving the payment data directly. A more detailed example may be useful to further explain payment processing via the iFrame system 300.

In one non-limiting example, a merchant 600 that sells items directly to consumers (e.g., pet supplies, clothing, kitchen equipment, etc.) on the internet 104 may deploy their website 602, as further disclosed herein, to accept payments via the iFrame system 300. Generally, continuing with this example, after the merchant's customer 102 determines the item(s) that he/she wishes to purchase, places them in his/her online shopping cart, and is ready to complete and pay for the order, the customer 102 will be directed to a payment page on the merchant's website 602.

This payment page, in various embodiments, will display an iFrame, or an embedded HTML document, (produced by the iFrame system 300) that permits the customer 102 to enter payment data directly into the iFrame system 300 via the merchant's website 602. Generally, the iFrame (via a JavaScript SDK) permits user interface customization such that it can display present and/or custom fonts, styles, languages, and layouts (that would all match those used on the payee website 602 so that the iFrame does not appear any different from the rest of the payee website 602). Thus, on that payment page, at step 1, in various embodiments, the customer 102 will be directed to enter their payment data into the provided spaces of the iFrame, which will depend on the method of payment selected, and other relevant/necessary non-sensitive payment data (e.g., customer name, contact information, etc.) will be collected by the merchant's website 602 outside of the iFrame. For example, the customer 102 may enter their credit card number, expiration date, and card verification value. That payment data will generally be provided directly, by the iFrame on the merchant website 602, to an iFrame controller 400 of the iFrame system 300 for generation of an eToken. In various embodiments, the eToken includes an encrypted identifier used by the iFrame system 300 and merchant website 602 to identify the provided payment data. In various embodiments, the payment data is provided to the iFrame controller 400 for eToken generation automatically and in real time as the payment data is entered by the customer. In an alternate embodiment, the payment data is provided to the iFrame controller only upon the customer 102 providing affirmative confirmation to do so (e.g., clicking a “Pay Now” button, as in step 3). After eToken generation, at step 2, in various embodiments, the eToken is provided back to the merchant website 602 so that the merchant 600 may associate it with the current transaction and other data for future processing.

Generally, after receiving the eToken at step 2 and after the customer provides affirmative confirmation at step 3, the merchant website 602 sends the transaction data (e.g., eToken, transaction price, transaction identifier, etc.) to an eToken transaction processor 500 in the iFrame system 300 for payment processing at step 4. Accordingly, the eToken transaction processor 500 receives the payment data and, in one embodiment, processes the payment through the appropriate payment network 106 (e.g., credit card company, bank, miner(s), etc.). Generally, the eToken transaction processor 500 provides the results of the payment processing to the merchant website 602 for subsequent action. For example, if the payment is confirmed, then the merchant 600 may, at step 5, provide an order confirmation page on the merchant website 602 and ship the ordered items to the customer 102. If, however, the payment is not confirmed, then the merchant 600 may display a transaction invalid page on the merchant website 602 that permits the customer 102 to provide new payment data or request processing of the transaction again. Thus, the iFrame system 300 facilitates online payments on a merchant website 602 via use of an iFrame that permits payment directly on the merchant website 602 without providing the merchant 600 with visibility into the payment data for that transaction.

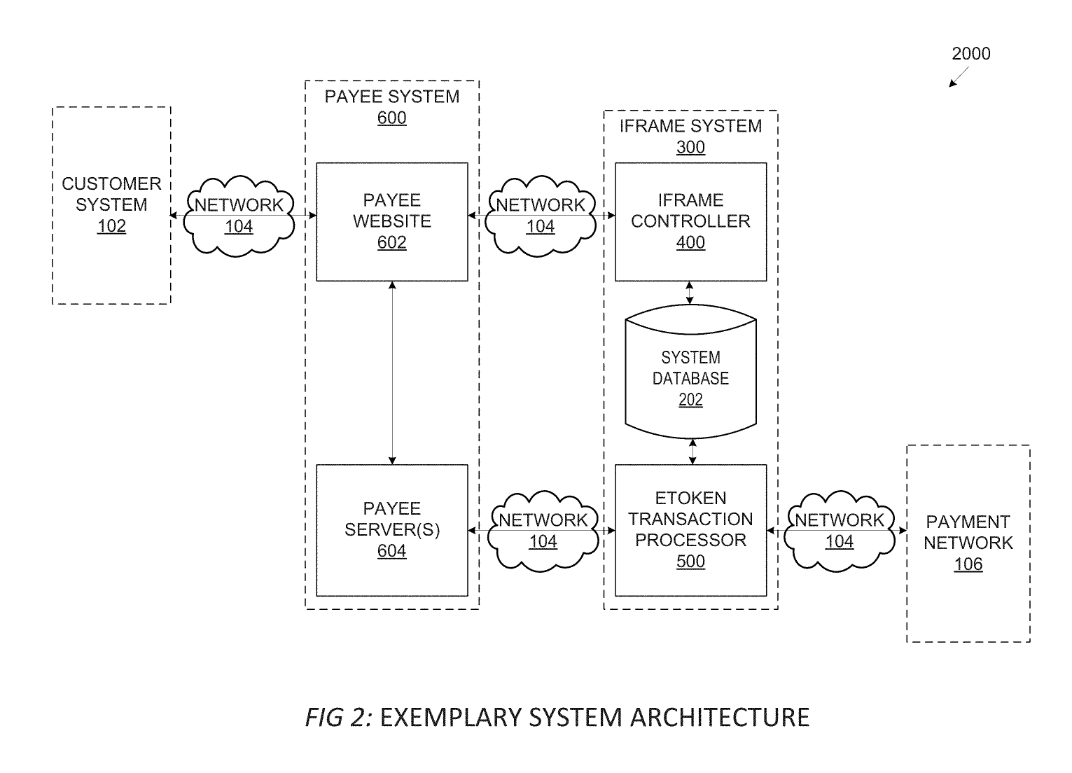

Now referring to FIG. 2, an exemplary architecture 2000 of one embodiment of the disclosed iFrame system 300 is shown. In various embodiments, the exemplary iFrame system 300 is operatively connected, via a network 104, to one or more payee system(s) 600 and one or more payment network(s) 106. Generally, network 104 may be any connection capable of transferring data between two or more computer systems (e.g., a secure or unsecured connection, Bluetooth, wireless or wired local-area networks (LANs), cell network, the Internet, etc.). As shown in FIG. 2, each network 104 may be a separate network for the communications shown or network 104 may be a single network through which all communications are routed. In various embodiments, the network 104 may facilitate secure communication via encryption or other methods.

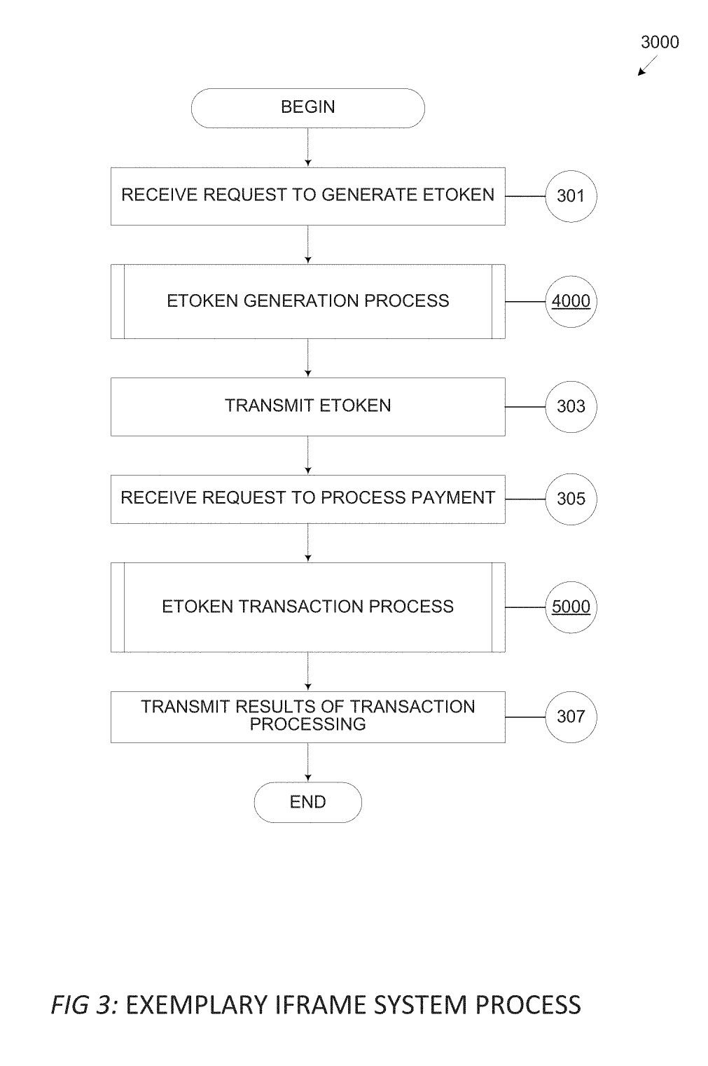

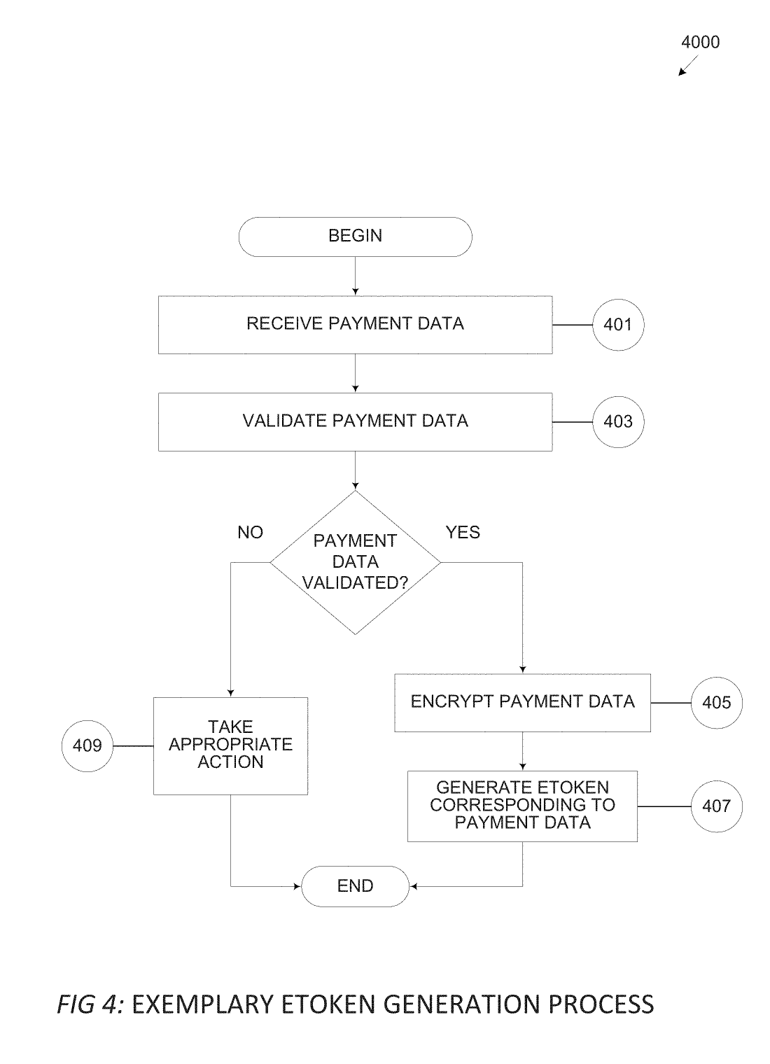

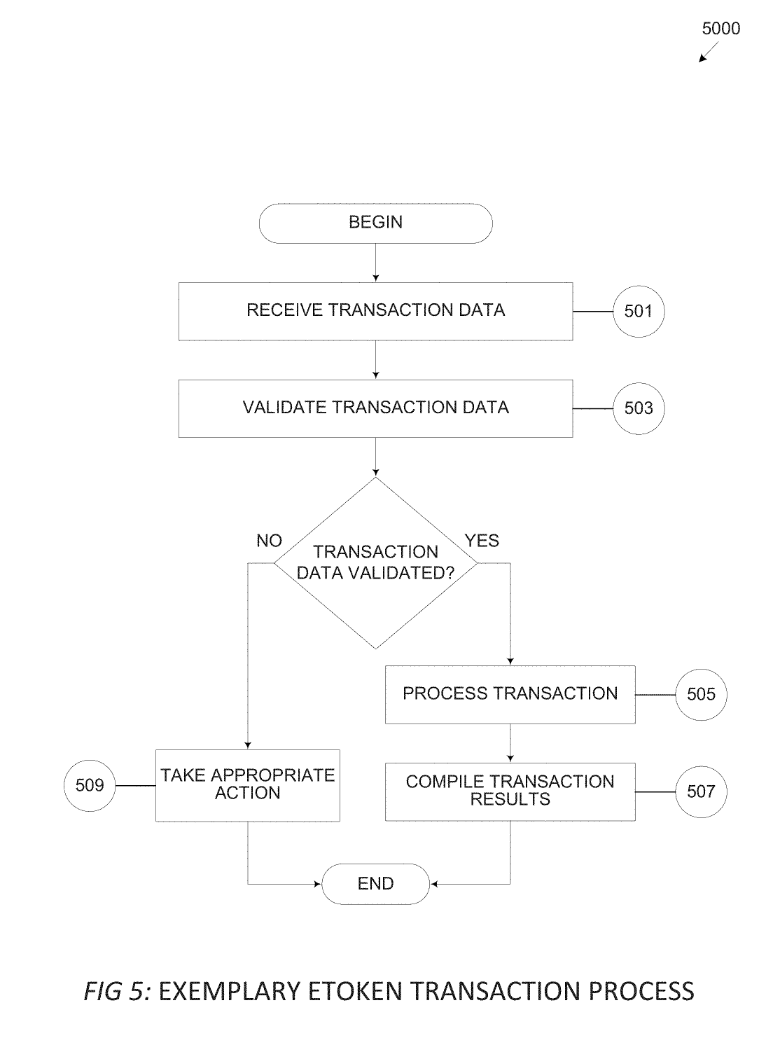

Generally, the iFrame system 300 may be any computing device (e.g., desktop computer, laptop, servers, tablets, etc.), combination of computing devices, software, hardware, or combination of software and hardware that is capable of performing the functionality disclosed herein, further details of which will be explained in association with the description of FIGS. 1 and 3. The exemplary iFrame system 300, in various embodiments, includes an iFrame controller 400, one or more system database(s) 202, and an eToken transaction processor 500. In one embodiment, the iFrame controller 400 conducts the eToken generation process (further details of which will be discussed in association with the description of FIG. 4), communicates with the payee website 602 and the system database 202, and may be any computing device (e.g., desktop computer, laptop, servers, tablets, etc.), combination of computing devices, software, hardware, or combination of software and hardware that is capable of performing the functionality disclosed herein. In one embodiment, the eToken transaction processor 500 conducts the eToken transaction process (further details of which will be discussed in association with the description of FIG. 5), communicates with the payee server(s) 604 and the system database 202, and may be any computing device (e.g., desktop computer, laptop, servers, tablets, etc.), combination of computing devices, software, hardware, or combination of software and hardware that is capable of performing the functionality disclosed herein. The system database 202, in various embodiments, may be any computing device (e.g., desktop computer, laptop, servers, tablets, etc.), combination of computing devices, software, hardware, combination of software and hardware, database (e.g., stored in the cloud or on premise, structured as relational, etc.), or combination of databases that is capable of performing the functionality disclosed herein.

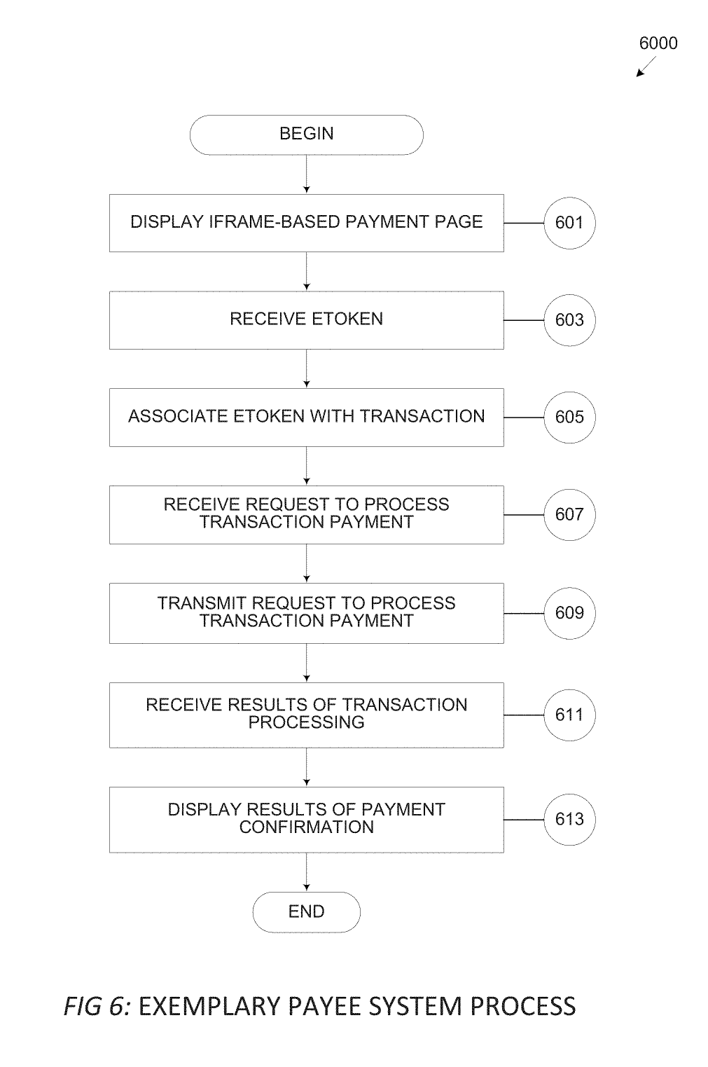

In various embodiments, an exemplary payee system 600 includes a payee website 602 and one or more payee server(s) 604. Generally, the exemplary payee system 600 is operatively connected, via the network 104, to the exemplary iFrame system 300 and one or more customer system(s) 102. The exemplary payee system 600 may be any computing device (e.g., desktop computer, laptop, servers, tablets, etc.), combination of computing devices, software, hardware, or combination of software and hardware that is capable of performing the functionality disclosed herein, further details of which will be explained in association with the description of FIGS. 1 and 6. In one embodiment, the payee website 602 is any website, mobile application, web page, collection of web pages, or other hardware/software (or combination of the same) that is capable of performing the functionality disclosed herein. In one embodiment, the payee server(s) 604 hosts the payee website 602, communicates with the eToken transaction processor 500, and may be any computing device (e.g., desktop computer, laptop, servers, tablets, etc.), combination of computing devices, software, hardware, or combination of software and hardware that is capable of performing the functionality disclosed herein.

Generally, the payee website 602 may be coded to produce an iFrame container that receives the iFrame from the iFrame system 300. For example, the payee website 602 may include a JavaScript SDK that manages the communications between the payee website 602 (e.g., an HTML page) and the iFrame (e.g., another HTML page). Generally, the SDK facilitates generation of an eToken (e.g., as part of process 4000). Further, in at least one embodiment, the SDK facilitates transmission of masked data. In one embodiment, the SDK automatically embeds the iFrame on the payee website 602. When a payor's internet browser on the customer system 102 detects that an iFrame is loaded from a domain (e.g., associated with the iFrame system 300) that differs from the payee website 602, in various embodiments, it increases the security applied to the payee website 602 considerably because the browser generally applies a mechanism that limits communications to a specific set of custom commands. The JavaScript SDK generally provides developer-friendly functions that hide complicated command messages. According to one or more embodiments, the SDK passes the encrypted eToken to the payee.

The customer system 102, in one embodiment, permits the customer to interact with the payee website 602 to conduct a transaction and is any is any device that is capable of performing the functionality disclosed herein (e.g., desktop computer, laptop computer, tablet computer, smartphone, smartwatch, etc.). As will occur to one having ordinary skill in the art, this disclosure places no limitations on the types of customer systems 102 that may be used as described herein.

Generally, the payment network 106 settles financial transactions, is generally operated by a financial institution (e.g., bank, credit card company, etc.), and may be any computing device (e.g., desktop computer, laptop, servers, tablets, etc.), combination of computing devices, software, hardware, or combination of software and hardware that is capable of performing the functionality disclosed herein. As will occur to one having ordinary skill in the art, this disclosure places no limitations on the types of payment networks 106 that may be used as described herein.

Referring now to FIG. 3, a flowchart of an exemplary iFrame system process 3000 is shown according to one embodiment of the present disclosure. As will be understood by one having ordinary skill in the art, the steps and processes shown in FIG. 3 (and those of all other flowcharts and sequence diagrams shown and described herein) may operate concurrently and continuously, are generally asynchronous and independent, and are not necessarily performed in the order shown. Generally, the exemplary iFrame system process 3000 is the process by which the iFrame system 300 receives and processes payment data as part of an online transaction initiated through a payee website 602.

In various embodiments, the exemplary iFrame system process 3000 begins at step 301, wherein the iFrame system 300 receives a request, via an iFrame on a payee website 602, to generate an eToken corresponding to one or more pieces of payment data (e.g., credit card number, routing number, expiration date, social security number, bitcoin address, etc.). In one embodiment, the exemplary iFrame system process 3000 begins when the iFrame system 300 generates/produces the iFrame that generates the request (in various embodiments, the iFrame includes a first HTML document that links to/is hosted by the iFrame system 300 and is embedded in a second HTML document—also known as an iFrame container—that is placed on the payee website 602, with this structure the payee website 602 cannot access/has no visibility into the data handled by the first HTML document, which is generally payment data). In various embodiments, the SDK accepts configuration options that automatically generates the iFrame styled to the payee's preference on the payee website 602. Generally, the request to generate an eToken may be generated automatically as payment data is entered into the iFrame (or when the iFrame detects entry of the same, via the SDK) or may be generated when the payor 102 provides affirmative confirmation to do so (e.g., clicks a “Pay Now” button, etc.). In one embodiment, the request may include the payment data. In one embodiment, the iFrame may provide the payment data to the iFrame controller 400 separate from the request. Thus, to generate the eToken, the iFrame system 300, in various embodiments, initiates the eToken generation process 4000, via the iFrame controller 400, further details of which will be discussed in association with the description of FIG. 4.

Once the eToken has been generated (as part of the process 4000), at step 303, in one embodiment, the iFrame system 300 transmits the eToken to the payee system 600 (e.g., the eToken is passed from the iFrame system 300 over the network 104 to the first HTML document on the payee's website 602, wherein the first HTML document then passes the eToken to the iFrame container where it is picked up by the JavaScript SDK), where it is associated with the particular transaction to which it pertains (e.g., using a callback function of the SDK to pass the eToken to the payee server 604). In various embodiments, the iFrame system 300 receives a request to process payment for the transaction at step 305. Generally, the request to process payment includes transaction data corresponding to the transaction (e.g., amount to be charged, eToken, transaction identifier, customer name, customer contact information, etc.). Accordingly, to process the transaction, the iFrame system 300, in various embodiments, initiates the eToken transaction process 5000, via the eToken transaction processor 500, further details of which will be discussed in association with the description of FIG. 5.

Generally, at step 307, after the transaction has been processed (as part of the process 5000), the iFrame system 300 transmits the results of the transaction processing (e.g., confirmation, rejection, request for additional information, etc.) to the payee system 600 for appropriate action and the exemplary iFrame system process 3000 ends thereafter.

Now referring to FIG. 4, a flowchart showing an exemplary eToken generation process 4000 is shown according to one embodiment of the present disclosure. Generally, the eToken generation process 4000 is the process by which the iFrame controller 400 generates an eToken representing/corresponding to the payment data entered by the payor 102. As will occur to one having ordinary skill in the art, this disclosure places no limitations on the type of payment data that may be accepted by the iFrame system 300 (e.g., credit card, debit card, bank account, cryptocurrency, etc.). Generally, an eToken is an identifier used by the iFrame system 300 and the payee system 600 to identify the payment data of the payor 102. In one embodiment, the eToken is encrypted or otherwise obfuscated by a cryptographic algorithm (e.g., RSA, AES, etc.), secure hash algorithm (e.g., SHA-256, etc.), or other system/method such that an unauthorized third party cannot access/use the data represented by the eToken.

In various embodiments, the exemplary eToken generation process 4000 begins at step 401 wherein the iFrame controller 400 receives the payment data from the iFrame on the payee's website 602. In one embodiment, the iFrame validates the payment data (e.g., confirms that it meets certain formatting standards, such as proper length for credit card numbers, credit verification values, routing numbers, proper date format, etc.; confirms that it has all of the payment data required; confirms that it comes from a live payor 102 and not a bot; etc.) prior to transmitting to the iFrame system 300. Generally, at step 403, the iFrame controller 400 performs additional security checks on the received payment data (e.g., the payment data was received in an expected format, the payment data was signed by the appropriate signature, etc.) to ensure that the correct payment data was received and that the received payment data was not a malicious attack (e.g., a third party impersonating the iFrame to infiltrate the iFrame system 300).

If the payment data passes the additional security checks, then, in one embodiment, the iFrame controller 400 encrypts the payment data (e.g., using a cryptographic algorithm, secure hash algorithm, etc.) and stores the encrypted payment data in the system database 202. Further, at step 407, in various embodiments, the iFrame controller 400 generates an eToken corresponding to the payment data and stores the eToken in the system database 202 in association with the encrypted payment data (and other data such as an identifier for the payee 600, etc.) and the exemplary eToken generation process 400 ends thereafter. If, however, the payment data does not pass the additional security checks, then the iFrame controller 400, in various embodiments, at step 409, takes the appropriate action (e.g., transmitting an error message, notifying the appropriate security personnel, monitoring the payment data, etc.) and the exemplary eToken generation process 400 ends thereafter.

Referring now to FIG. 5, a flowchart of an exemplary eToken transaction process 5000 is shown according to one embodiment of the present disclosure. Generally, the eToken transaction process 5000 is the process by which the eToken transaction processor 500 processes the transaction requested by the payor 102.

In various embodiments, the exemplary eToken transaction process 5000 begins at step 501 wherein the eToken transaction processor 500 receives the transaction data from the payee's server(s) 604. Generally, at step 503, the eToken transaction processor 500 validates the transaction data (e.g., the eToken, the payee, etc.) to ensure that the correct transaction data was received and that the received transaction data was not a malicious attack (e.g., a third party impersonating the payee 600 to process fake payments, etc.). In one embodiment, if the transaction data (and, in particular, the eToken) is not received within a certain timeframe (e.g., 1 minute, 3 minutes, 5 minutes, 10 minutes, etc.) beginning after generation of the eToken (e.g., at step 407), then the eToken transaction processor may not validate the transaction data.

If the transaction data is validated, then, in one embodiment, the eToken transaction processor 500 retrieves the payment data corresponding to the eToken in the transaction data from the system database 202 (e.g., in one embodiment, the eToken must first be decrypted to determine the appropriate eToken) and processes the transaction, via the appropriate payment network 106, according to the other information in the transaction data. Further, at step 507, in various embodiments, the eToken transaction processor 500 compiles the transaction results (e.g., payment confirmation, payment rejection, etc.) for transmission to the payee system 600 and the exemplary eToken transaction process 500 ends thereafter.

If, however, the transaction data cannot be validated, then the eToken transaction processor 500, in various embodiments, at step 509, takes the appropriate action (e.g., transmitting an error message, notifying the appropriate security personnel, logging the error, etc.) and the exemplary eToken transaction process 500 ends thereafter. In one embodiment, at step 509, an error message in the iFrame is displayed to the payor with the incorrect data field blank/highlighted and the remaining correct data fields masked (e.g., obscured fully or partially, etc.), so that the payor may re-enter the incorrect data. In one embodiment, the error field is populated from the appropriate eToken and one or more masked data objects (transmitted via the JavaScript SDK). If the payor does not modify any of the data in the data fields, then the eToken and one or more masked data objects remain unchanged. However, if the payor does modify any of the data in the data fields (e.g., the incorrect field, the masked field, etc.), then the new data is used to generate a new eToken and/or masked data objects.

Now referring to FIG. 6, a flowchart of an exemplary payee system process 6000 is shown according to one embodiment of the present disclosure. Generally, the exemplary payee system process 6000 is the process by which the payee system 600 facilitates an online payment to the payee 600 as part of an online transaction initiated through the payee's website 602.

In various embodiments, the exemplary payee system process 6000 begins at step 601 wherein the payee website 602 displays a payment page including an iFrame. Generally, the payor 102 will input payment data, using an electronic computing device, into the iFrame, and, at step 603 if validated, the payee 600 will receive the eToken generated by the iFrame system 300 corresponding to the entered payment data for use with the transaction. If the payee 600 does not receive an eToken at step 603, it may, in one embodiment, be configured to transmit an error message to the payor 102 or request additional information from the payor 102.

Generally, at step 605, the payee server(s) 604 associates the eToken with the particular transaction so that the payee 600 can identify the appropriate payment data to the iFrame system 300. In one embodiment, at step 607, the payee server(s) 604 receives a request from the payor 102 to process the payment for the transaction. Accordingly, at step 609, in various embodiments, the payee server(s) 604 gathers the appropriate transaction data and transmit a request to process the payment for the transaction to the iFrame system 300.

In various embodiments, the payee server(s) 604 receives the results of the transaction processing at step 611. In one embodiment, the payee server(s) 604 displays the results of the transaction processing on the payee website 602 (e.g., order confirmation if the payment was successful, request for additional information or transaction declined if the payment was not successful, etc.), at step 613, and the exemplary payee system process 6000 ends thereafter.

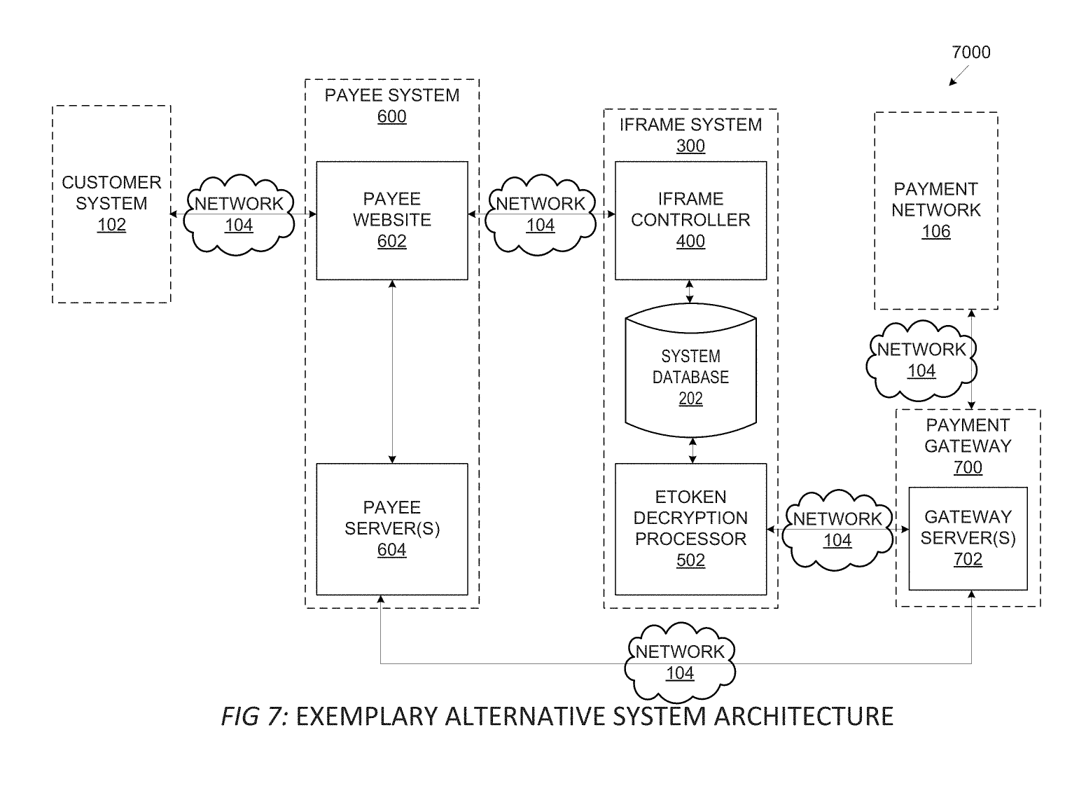

Referring now to FIG. 7, an exemplary alternative architecture 7000 of one embodiment of the disclosed iFrame system 300 is shown. Generally, the exemplary alternative architecture 7000 is the same as the exemplary architecture 2000 (shown in FIG. 2); thus, except as described below, the description of FIG. 2 (as well as FIGS. 3-6) is applicable to FIG. 7. In various embodiments, the exemplary iFrame system 300 is operatively connected, via a network 104, to one or more payee system(s) 600 and one or more payment gateway(s) 700 to perform the iFrame system process 3000.

Generally, the iFrame system 300 includes an iFrame controller 400, one or more system database(s) 202, and an eToken decryption processor/service 502. In one embodiment, the eToken decryption processor 502 decrypts eTokens (in one embodiment, as part of the eToken transaction process 5000), communicates with the payee server(s) 604, the system database 202, and the gateway server(s) 702, and may be any computing device (e.g., desktop computer, laptop, servers, tablets, etc.), combination of computing devices, software, hardware, or combination of software and hardware that is capable of performing the functionality disclosed herein.

In various embodiments, the payment gateway 700 is a third party system that processes payments (e.g., credit card payments, direct payments, etc.) and/or communicates with systems (e.g., iFrame system 300, payee system 600, etc.) on behalf of the payment network 106. Generally, the payment gateway 700 includes one or more gateway server(s) 702. In one embodiment, the payment gateway 700 communicates with the payment network 106, iFrame system 300, and payee system 600. In various embodiments, the payment gateway 700 and gateway server(s) 702 may be any computing device (e.g., desktop computer, laptop, servers, tablets, etc.), combination of computing devices, software, hardware, or combination of software and hardware that is capable of performing the functionality disclosed herein. In one embodiment, the payment network 106 comprises the payment gateway 700, and the payment gateway 700 interfaces with systems outside the payment network 106 (e.g., iFrame system 300, payee system 600, etc.).

Continuing with the embodiment shown in FIG. 7, the system database 202 persists encrypted cardholder data (e.g., received from the iFrame Controller 400). In various embodiments, the payee server 604, transmits the eToken to the gateway server(s) 702 (e.g., with additional, non-sensitive transaction data, such as the customer's name, address, etc., in at least one embodiment; for example, at step 609 of the payee system process 6000). In these embodiments, the gateway server(s) 702 then transmit the eToken to the eToken decryption processor 502, where the eToken is validated (e.g., decrypting the eToken, confirming it is a valid eToken, confirming the eToken was received in a valid time window, etc.), encrypted cardholder data is pulled (or otherwise received) from the system database 202, and the cardholder data is decrypted and sent back to the gateway server(s) 702. As will be understood, once the gateway server(s) 702 receive the unencrypted cardholder data, the payment gateway 700 may process the cardholder data via the payment network 106 (e.g., at steps 503-509 of the eToken transaction process 5000), reporting the results of the processing to the payee server 604.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can include various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a computer.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions include, for example, instructions and data which cause a computer to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system (and/or method) are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically includes one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

### Alternate Aspects

Various aspects of the present systems and methods will now be described. It will be understood by one of ordinary skill in the art that any of the aspects below may incorporate and include any other aspects mentioned below or features described herein. Therefore, the aspects below should be understood to include any combination of aspects and should not be limited to the combinations presented below. For example, although the second aspect includes the computer system of the first aspect, it may also include features of the twenty-sixth aspect, the first aspect, or the hundredth aspect.

According to a first aspect, a system, including: A) an iFrame controller that: 1) produces an iFrame on a merchant web site hosted on a server; 2) receives payment data from the iFrame corresponding to a transaction on the merchant website; 3) encrypts and stores the received payment data; 4) generates an eToken corresponding to the encrypted payment data; and 5) transmits the eToken to the server, wherein the server transmits the eToken to a payment gateway server; and B) an eToken decryption processor that: 1) receives, from the payment gateway server the eToken; 2) authenticates the eToken to determine the encrypted payment data to which it corresponds; 3) decrypts the encrypted payment data; and 4) transmits the decrypted payment data to the payment gateway server for processing the transaction.

According to a second aspect, the system or method of the first aspect or any other aspect, wherein the iFrame includes a first HTML document embedded within a second HTML document.

According to a third aspect, the system or method of the first aspect or any other aspect, wherein the received payment data includes at least one of the following: a credit card number, a credit card expiration date, a credit card verification value, a bank account routing number, a debit card number, a debit card expiration date, or a PIN number.

According to a fourth aspect, the system or method of the third aspect or any other aspect, wherein the payment data is not accessible by the merchant web site or the server.

According to a fifth aspect, the system or method of the first aspect or any other aspect, wherein the payment gateway server and the iFrame controller are managed separately from the server.

According to a sixth aspect, the system or method of the first aspect or any other aspect, wherein the iFrame controller encrypts the eToken prior to transmitting the eToken to the server.

According to a seventh aspect, the system or method of the sixth aspect or any other aspect, wherein the eToken decryption processor decrypts the eToken prior to authenticating the eToken.

According to an eighth aspect, the system or method of the first aspect or any other aspect, wherein the iFrame includes one or more font or text styles that match a font or text style on the merchant website.

According to a ninth aspect, the system or method of the eighth aspect or any other aspect, wherein the iFrame controller is configured to substantially automatically match the font or text style on the merchant website based on user-input for creating the iFrame.

According to a tenth aspect, the system or method of the first aspect or any other aspect, wherein the iFrame controller produces the iFrame based at least in part on inputs from an iFrame builder user-interface that enables a merchant to input iFrame parameters.

According to an eleventh aspect, the system or method of the tenth aspect or any other aspect, wherein the iFrame builder user-interface includes commands that enable the merchant to match fonts and/or text styles on the merchant website.

According to a twelfth aspect, a method, including the steps of: A) producing an iFrame on a merchant web site hosted on a server; B) receiving payment data from the iFrame corresponding to a transaction on the merchant website; C) encrypting the received payment data; storing the encrypted payment data; D) generating an eToken corresponding to the encrypted payment data; E) transmitting the eToken to the server, wherein the server transmits the eToken to a payment gateway server; F) receiving, from the payment gateway server, the eToken; G) authenticating the eToken to determine the encrypted payment data to which it corresponds; H) decrypting the encrypted payment data; and I) transmitting the decrypted payment data to the payment gateway server for processing the transaction.

According to a thirteenth aspect, the system or method of the twelfth aspect or any other aspect, wherein the iFrame includes a first HTML document embedded within a second HTML document.

According to a fourteenth aspect, the system or method of the twelfth aspect or any other aspect, wherein the received payment data includes at least one of the following: a credit card number, a credit card expiration date, a credit card verification value, a bank account routing number, a debit card number, a debit card expiration date, or a PIN number.

According to a fifteenth aspect, the system or method of the fourteenth aspect or any other aspect, wherein the payment data is not accessible by the merchant website or the server.

According to a sixteenth aspect, the system or method of the twelfth aspect or any other aspect, wherein the payment gateway server is managed separately from the server.

According to a seventeenth aspect, the system or method of the twelfth aspect or any other aspect, further including the step of encrypting the eToken prior to transmitting the eToken to the server.

According to an eighteenth aspect, the system or method of the seventeenth aspect or any other aspect, further including the step of decrypting the eToken prior to authenticating the eToken.

According to a nineteenth aspect, a system, including: A) a web site hosted on a server, wherein the web site includes an iFrame and the iFrame receives payment data corresponding to a transaction on the website and is produced by an iFrame controller; and B) the server that: 1) receives an eToken corresponding to the received payment data from the iFrame controller; 2) generates transaction data, corresponding to the transaction, including the eToken and non-sensitive payment data; 3) transmits the transaction data to a payment gateway server for processing of the transaction; and 4) receives at least one result of the processing from the payment gateway server.

According to a twentieth aspect, the system or method of the nineteenth aspect or any other aspect, wherein the payment gateway server transmits the eToken to an eToken decryption processer operatively connected to the iFrame controller and a database stores the received payment data.

According to a twenty-first aspect, the system or method of the twentieth aspect or any other aspect, wherein, in response to transmitting the eToken to the eToken decryption processor, the payment gateway server receives the received payment data.

According to a twenty-second aspect, the system or method of the nineteenth aspect or any other aspect, wherein the iFrame includes a first HTML document embedded within a second HTML document.

According to a twenty-third aspect, the system or method of the nineteenth aspect or any other aspect, wherein the received payment data includes at least one of the following: a credit card number, a credit card expiration date, a credit card verification value, a bank account routing number, a debit card number, a debit card expiration date, or a PIN number.

According to a twenty-fourth aspect, the system or method of the twenty-third aspect or any other aspect, wherein the payment data is not accessible by the website or the server.

According to a twenty-fifth aspect, the system or method of the twenty-fourth aspect or any other aspect, wherein the non-sensitive payment data includes at least one of the following: a transaction identifier, a transaction price, or contact information.

According to a twenty-sixth aspect, the system or method of the twenty-fifth aspect or any other aspect, wherein the payment gateway server is managed separately from the server.

According to a twenty-seventh aspect, a method, including the steps of: A) hosting a web site that includes an iFrame, wherein the iFrame receives payment data corresponding to a transaction on the website; B) receiving an eToken corresponding to the received payment data; C) generating transaction data, corresponding to the transaction, including the eToken and non-sensitive payment data; D) transmitting the transaction data for processing of the transaction; and E) receiving at least one result of the processing.

According to a twenty-eighth aspect, the system or method of the twenty-seventh aspect or any other aspect, wherein the iFrame includes a first HTML document embedded within a second HTML document.

According to a twenty-ninth aspect, the system or method of the twenty-eighth aspect or any other aspect, wherein the received payment data includes at least one of the following: a credit card number, a credit card expiration date, a credit card verification value, a bank account routing number, a debit card number, a debit card expiration date, or a PIN number.

According to a thirtieth aspect, the system or method of the twenty-ninth aspect or any other aspect, wherein the payment data is not accessible by the website.

According to a thirty-first aspect, the system or method of the thirtieth aspect or any other aspect, wherein the non-sensitive payment data includes at least one of the following: a transaction identifier, a transaction price, or contact information.

According to a thirty-second aspect a system, including: A) an iFrame controller that: 1) produces an iFrame on a merchant web site hosted on a server; 2) receives payment data from the iFrame corresponding to a transaction on the merchant website; 3) generates an eToken corresponding to the received payment data; and 4) transmits the eToken to the server; and B) an eToken transaction processor that: 1) receives, from the server, transaction data, including the eToken and non-sensitive payment data, corresponding to the transaction; 2) authenticates the eToken to determine the received payment data to which it corresponds; and 3) processes the transaction, according to the received transaction data, using the received payment data.

According to a thirty-third aspect, the system or method of the thirty-second aspect or any other aspect, wherein the iFrame includes a first HTML document embedded within a second HTML document.

According to a thirty-fourth aspect, the system or method of the thirty-second aspect or any other aspect, wherein the received payment data includes at least one of the following: a credit card number, a credit card expiration date, a credit card verification value, a bank account routing number, a debit card number, a debit card expiration date, or a PIN number.

According to a thirty-fifth aspect, the system or method of the thirty-fourth aspect or any other aspect, wherein the payment data is not accessible by the merchant website or the server.

According to a thirty-sixth aspect, the system or method of the thirty-second aspect or any other aspect, wherein the non-sensitive payment data includes at least one of the following: a transaction identifier, a transaction price, or contact information.

According to a thirty-seventh aspect, the system or method of the thirty-second aspect or any other aspect, wherein the iFrame controller encrypts the eToken prior to transmitting the eToken to the server.

According to a thirty-eighth aspect, the system or method of the thirty-seventh aspect or any other aspect, wherein the eToken transaction processor decrypts the eToken prior to authenticating the eToken.

According to a thirty-ninth aspect, the system or method of the thirty-second aspect or any other aspect, wherein the eToken transaction processor, to process the transaction, transmits the payment data and at least some of the transaction data to a payment network.

According to a fortieth aspect, a method, including the steps of: A) producing an iFrame on a merchant website hosted on a server; B) receiving payment data from the iFrame corresponding to a transaction on the merchant website; C) generating an eToken corresponding to the received payment data; D) transmitting the eToken to the server; E) receiving, from the server, transaction data, including the eToken and non-sensitive payment data, corresponding to the transaction; F) authenticating the eToken to determine the received payment data to which it corresponds; and G) processing the transaction, according to the received transaction data, using the received payment data.

According to a forty-first aspect, the system or method of the fortieth aspect or any other aspect, wherein the iFrame includes a first HTML document embedded within a second HTML document.

According to a forty-second aspect, the system or method of the fortieth aspect or any other aspect, wherein the received payment data includes at least one of the following: a credit card number, a credit card expiration date, a credit card verification value, a bank account routing number, a debit card number, a debit card expiration date, or a PIN number.

According to a forty-third aspect, the system or method of the forty-second aspect or any other aspect, wherein the payment data is not accessible by the merchant web site or the server.

According to a forty-forth aspect, the system or method of the fortieth aspect or any other aspect, wherein the non-sensitive payment data includes at least one of the following: a transaction identifier, a transaction price, or contact information.

According to a forty-fifth aspect, the system or method of the fortieth aspect or any other aspect, further including the step of encrypting the eToken prior to transmitting the eToken to the server.

According to a forty-sixth aspect, the system or method of the forty-fifth aspect or any other aspect, further including the step of decrypting the eToken prior to authenticating the eToken.

According to a forty-seventh aspect, the system or method of the fortieth aspect or any other aspect, wherein processing the transaction further including the step of transmitting the payment data and at least some of the transaction data to a payment network.

According to a forty-eighth aspect, a system, including: A) a web site hosted on a server, wherein the web site includes an iFrame, wherein the iFrame receives payment data corresponding to a transaction on the website and is produced by an iFrame controller; and B) the server that: 1) receives an eToken corresponding to the received payment data from the iFrame controller; 2) generates transaction data, corresponding to the transaction, including the eToken and non-sensitive payment data; 3) transmits the transaction data to an eToken transaction processor for processing of the transaction; and 4) receives at least one result of the processing from the eToken transaction processor.

According to a forty-ninth aspect, the system or method of the forty-eighth aspect or any other aspect, wherein the iFrame includes a first HTML document embedded within a second HTML document.

According to a fiftieth aspect, the system or method of the forty-eighth aspect or any other aspect, wherein the received payment data includes at least one of the following: a credit card number, a credit card expiration date, a credit card verification value, a bank account routing number, a debit card number, a debit card expiration date, or a PIN number.

According to a fifty-first aspect, the system or method of the fiftieth aspect or any other aspect, wherein the payment data is not accessible by the website or the server.

According to a fifty-second aspect, the system or method of the forty-eighth aspect or any other aspect, wherein the non-sensitive payment data includes at least one of the following: a transaction identifier, a transaction price, or contact information.

### CONCLUSION

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

The embodiments were chosen and described in order to explain the principles of the claimed systems and their practical application so as to enable others skilled in the art to utilize the systems and various embodiments and with various modifications as are suited to the particular use contemplated. Alternative embodiments will become apparent to those skilled in the art to which the claimed systems pertain without departing from their spirit and scope. Accordingly, the scope of the claimed systems is defined by the appended claims rather than the foregoing description and the exemplary embodiments described therein.

What is claimed is:

1. A system, comprising:
an iFrame controller that:
produces an iFrame on a merchant website hosted on a server;
receives payment data from the iFrame corresponding to a transaction on the merchant website;
generates an eToken corresponding to the received payment data; and
transmits the eToken to the server; and
an eToken transaction processor that:
receives, from the server, transaction data, comprising the eToken and non-sensitive payment data, corresponding to the transaction;
authenticates the eToken to determine the received payment data to which it corresponds; and
processes the transaction, according to the received transaction data, using the received payment data.

2. The system of claim 1, wherein the iFrame comprises a first HTML document embedded within a second HTML document.

3. The system of claim 1, wherein the received payment data comprises at least one of the following: a credit card number, a credit card expiration date, a credit card verification value, a bank account routing number, a debit card number, a debit card expiration date, or a PIN number.

4. The system of claim 3, wherein the payment data is not accessible by the merchant website or the server.

5. The system of claim 1, wherein the non-sensitive payment data comprises at least one of the following: a transaction identifier, a transaction price, or contact information.

6. The system of claim 1, wherein the iFrame controller encrypts the eToken prior to transmitting the eToken to the server.

7. The system of claim 6, wherein the eToken transaction processor decrypts the eToken prior to authenticating the eToken.

8. The system of claim 1, wherein the eToken transaction processor, to process the transaction, transmits the payment data and at least some of the transaction data to a payment network.

9. A method, comprising the steps of:
producing an iFrame on a merchant web site hosted on a server;
receiving payment data from the iFrame corresponding to a transaction on the merchant web site;
generating an eToken corresponding to the received payment data;
transmitting the eToken to the server;
receiving, from the server, transaction data, comprising the eToken and non-sensitive payment data, corresponding to the transaction;
authenticating the eToken to determine the received payment data to which it corresponds; and
processing the transaction, according to the received transaction data, using the received payment data.

10. The method of claim 9, wherein the iFrame comprises a first HTML document embedded within a second HTML document.

11. The method of claim 9, wherein the received payment data comprises at least one of the following: a credit card number, a credit card expiration date, a credit card verification value, a bank account routing number, a debit card number, a debit card expiration date, or a PIN number.

12. The method of claim 11, wherein the payment data is not accessible by the merchant web site or the server.

13. The method of claim 9, wherein the non-sensitive payment data comprises at least one of the following: a transaction identifier, a transaction price, or contact information.

14. The method of claim 9, further comprising the step of encrypting the eToken prior to transmitting the eToken to the server.

15. The method of claim 14, further comprising the step of decrypting the eToken prior to authenticating the eToken.

16. The method of claim 9, wherein processing the transaction further comprising the step of transmitting the payment data and at least some of the transaction data to a payment network.

17. A system, comprising:
a website hosted on a server, wherein the website comprises an iFrame, wherein the iFrame receives payment data corresponding to a transaction on the website and is produced by an iFrame controller; and
the server that:
receives an eToken corresponding to the received payment data from the iFrame controller;
generates transaction data, corresponding to the transaction, comprising the eToken and non-sensitive payment data;
transmits the transaction data to an eToken transaction processor for processing of the transaction; and
receives at least one result of the processing from the eToken transaction processor.

18. The system of claim 17, wherein the iFrame comprises a first HTML document embedded within a second HTML document.

19. The system of claim 17, wherein the received payment data comprises at least one of the following: a credit card number, a credit card expiration date, a credit card verification value, a bank account routing number, a debit card number, a debit card expiration date, or a PIN number.

20. The system of claim 19, wherein the payment data is not accessible by the website or the server.

21. The system of claim 17, wherein the non-sensitive payment data comprises at least one of the following: a transaction identifier, a transaction price, or contact information.

22. A method, comprising the steps of:
hosting a website that comprises an iFrame, wherein the iFrame receives payment data corresponding to a transaction on the website;
receiving an eToken corresponding to the received payment data;
generating transaction data, corresponding to the transaction, comprising the eToken and non-sensitive payment data;
transmitting the transaction data for processing of the transaction; and
receiving at least one result of the processing.

23. The method of claim 22, wherein the iFrame comprises a first HTML document embedded within a second HTML document.

24. The method of claim 22, wherein the received payment data comprises at least one of the following: a credit card number, a credit card expiration date, a credit card verification value, a bank account routing number, a debit card number, a debit card expiration date, or a PIN number.

25. The method of claim 24, wherein the payment data is not accessible by the website.

26. The method of claim 22, wherein the non-sensitive payment data comprises at least one of the following: a transaction identifier, a transaction price, or contact information.
